(19) United States
(12) Patent Application Publication
(10) Pub. No.: US 2025/0206641 A1
(43) Pub. Date: Jun. 26, 2025

(54) FLUID TREATMENT DEVICE

(71) Applicant: Nichia Corporation, Anan-shi (JP)

(72) Inventors: Masahiro IMAI, Chino-shi (JP); Naoki NAKAMURA, Suwa-gun (JP); Katsuyuki ONOZUKA, Nagano-shi (JP)

(21) Appl. No.: 18/980,489

(22) Filed: Dec. 13, 2024

(30) Foreign Application Priority Data
Dec. 25, 2023 (JP) 2023-217759

(51) Int. Cl. C02F 1/32

(52) U.S. Cl. CPC C02F 1/32; C02F 2201/3227; C02F 2201/3228; C02F 2201/326; C02F 2303/04

(57) ABSTRACT

A fluid treatment device includes a flow path member having a flow path through which a fluid (e.g., water W) to be treated flows, first and second cover members forming spaces separated from the flow path and including light-transmissive parts disposed between the spaces, respectively, and the flow path, first and second light sources disposed in the spaces formed by the first and second cover members, respectively, to emit light toward the flow path, and a first light detector disposed in the space formed by the first cover member. A first light detector receives a first light flux that is emitted from the first light source and reaches the first light detector without passing through the flow path and a second light flux that is emitted from the first light source and reaches the first light detector after passing through the flow path.

### CROSS-REFERENCE TO RELATED APPLICATIONS

This application claims priority to Japanese Patent Application No. 2023-217759 filed on Dec. 25, 2023, the disclosure of which is hereby incorporated by reference in its entirety.

### BACKGROUND

The present invention relates to a fluid treatment device.

Conventionally, a sterilization treatment of a fluid is performed by irradiating a fluid flowing through a flow path with ultraviolet light. For example, Japanese Patent Application Publication No. 2019-037459 (hereinafter, Patent Document 1) discloses a fluid treatment device that irradiates a fluid with ultraviolet light emitted from a light source through a first surface of a window member. In order to improve monitoring accuracy of ultraviolet light, the fluid treatment device disclosed in Patent Document 1 includes a first light-detecting member disposed so as to receive ultraviolet light emitted through a surface different from the first surface of the window member, and a second light-detecting member disposed so as to receive ultraviolet light having passed through the fluid in the flow path.

That is, in the fluid treatment device disclosed in Patent Document 1, the first light-detecting member and the second light-detecting member are separately provided.

### SUMMARY

The present invention has been made in light of a technical problem that existed in conventional fluid treatment devices, and an object of the present invention is to provide a fluid treatment device that can simplify a device configuration.

A fluid treatment device according to an aspect of the present invention includes a flow path member having a flow path through which a fluid to be treated flows; a first cover member provided at a first end of the flow path member in a flow direction, the first cover member forming a first space separated from the flow path and including a first light-transmissive part disposed between the first space and the flow path; a first light source disposed in the first space and configured to emit light toward the flow path; and a first light detector disposed in the first space and configured to receive a first light flux that is emitted from the first light source and reaches the first light detector without passing through the flow path and a second light flux that is emitted from the first light source and reaches the first light detector after passing through the flow path.

In the fluid treatment device according to the above aspect of the present invention, since the first partial light that has not passed through the flow path and the second partial light that has passed through the flow path are received by the first light detector, the device configuration can be simplified.

### BRIEF DESCRIPTION OF DRAWINGS

FIG. 1 schematically illustrates a cross-sectional view of an example of a fluid treatment device according to a first embodiment.

FIG. 2 schematically illustrates a cross-sectional view of the fluid treatment device taken along line II-II in FIG. 1.

FIG. 3 schematically illustrates a cross-sectional view of the fluid treatment device with an optical path of light emitted from a first light source.

FIG. 4 schematically illustrates a cross-sectional view of the fluid treatment device with an optical path of light emitted from a second light source.

FIG. 5 is a timing chart showing an example of abnormality detection processing when an abnormality of the first light source is detected.

FIG. 6 is a timing chart showing an example of abnormality detection processing when an abnormality of a flow path or light-transmissive parts is detected based on a light amount value of a first light detector.

FIG. 7 is a timing chart showing an example of abnormality detection processing when an abnormality of the second light source is detected.

FIG. 8 is a timing chart showing an example of abnormality detection processing when an abnormality of the flow path or the light-transmissive parts is detected based on a light amount value of a second light detector.

FIG. 9 is a flowchart showing an example of abnormality detection processing.

FIG. 10 schematically illustrates a cross-sectional view of an example of a fluid treatment device according to a second embodiment.

FIG. 11 is a timing chart showing an example of abnormality detection processing when an abnormality of the first light source is detected according to the second embodiment.

FIG. 12 is a timing chart showing an example of abnormality detection processing when an abnormality of the second light source is detected according to the second embodiment.

FIG. 13 is a timing chart showing an example of abnormality detection processing when an abnormality of the flow path or the light-transmissive parts is detected according to the second embodiment.

FIG. 14 schematically illustrates a cross-sectional view of an example of a fluid treatment device according to a third embodiment.

FIG. 15 is a timing chart showing an example of abnormality detection processing when an abnormality of the first light source is detected according to the third embodiment.

FIG. 16 is a timing chart showing an example of abnormality detection processing when an abnormality of the flow path or the light-transmissive part is detected according to the third embodiment.

FIG. 17 schematically illustrates a cross-sectional view of an example of a schematic fluid treatment device according to a fourth embodiment.

### DETAILED DESCRIPTIONS

Embodiments of the present invention are described below with reference to the drawings. It is noted that fluid treatment devices according to the embodiments are intended to embody the technical concepts of the present invention, and the present invention is not limited to the following unless specifically stated. The sizes and positional relationships of members illustrated in the drawings may or may not be appropriately exaggerated, or some of the members may or may not be simplified or omitted.

In the present embodiment, an XYZ orthogonal coordinate system is employed for convenience of explanation. Specifically, a flow direction of a flow path (details are described below) included in the fluid treatment devices according to the embodiments is referred to as a “Z axis”, and two directions each orthogonal to the flow direction are respectively referred to as an “X axis” and a “Y axis”.

### First Embodiment

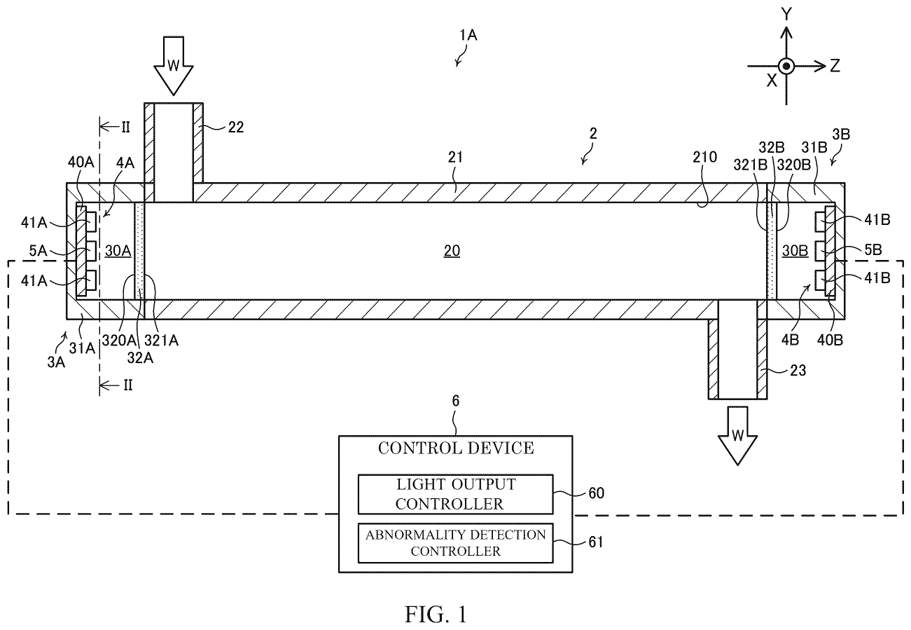

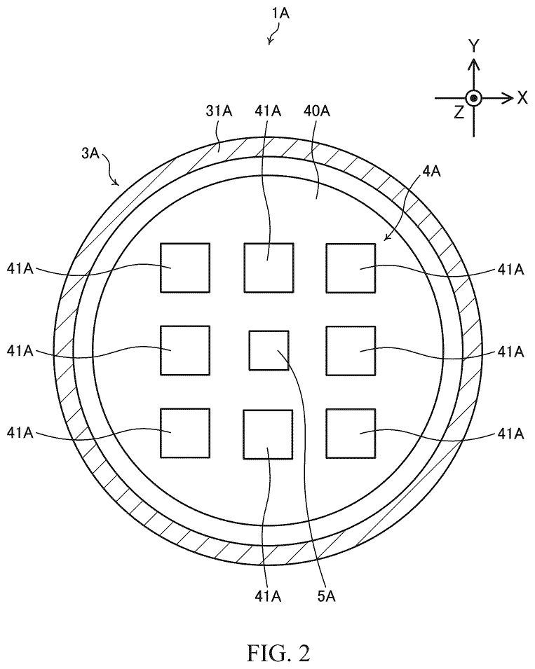

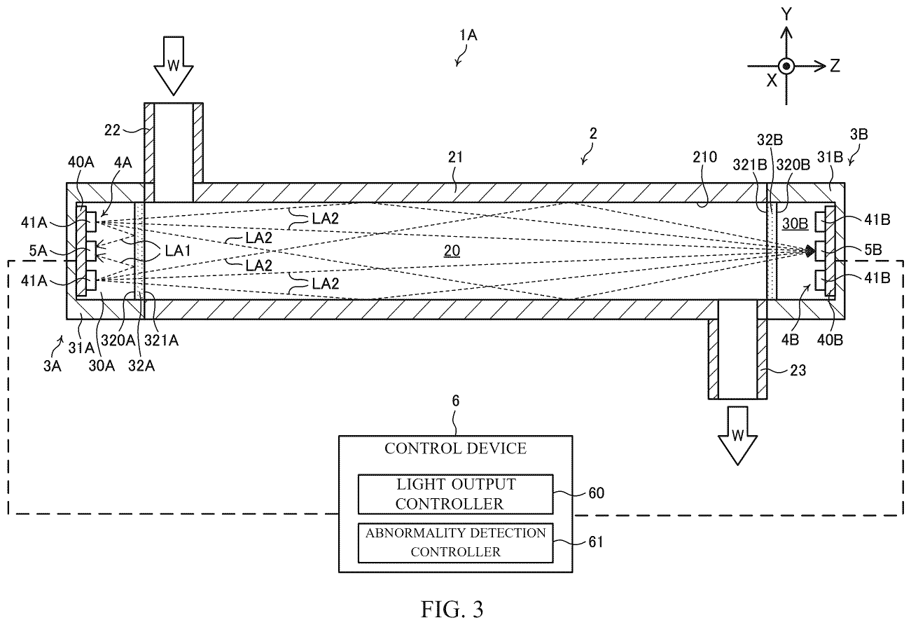

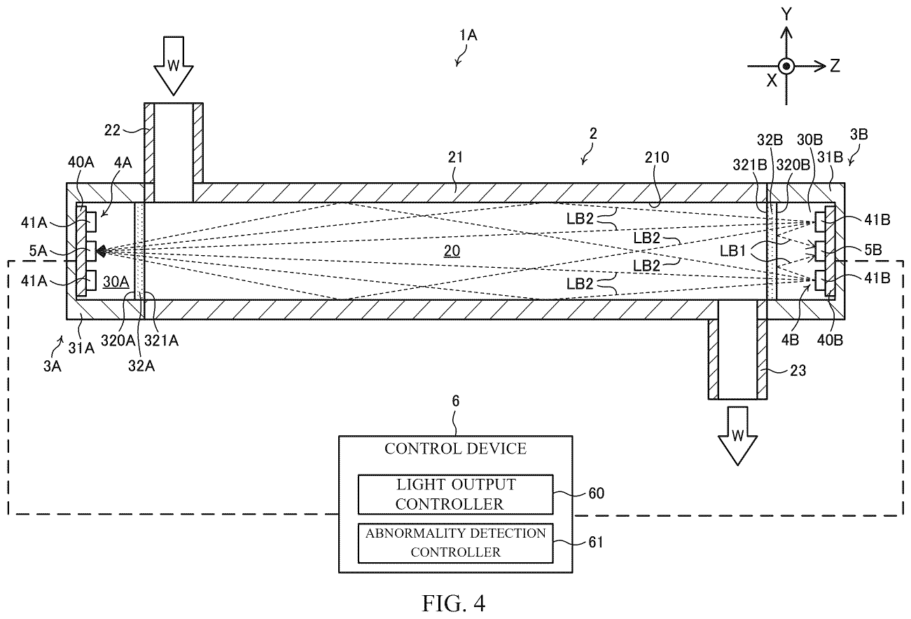

FIG. 1 schematically illustrates a cross-sectional view of an example of a fluid treatment device 1A according to a first embodiment. FIG. 2 schematically illustrates a cross-sectional view of the fluid treatment device 1A taken along line II-II in FIG. 1. FIG. 3 schematically illustrates a cross-sectional view of the fluid treatment device 1A with an optical path of light emitted from a first light source 4A. FIG. 4 schematically illustrates a cross-sectional view of the fluid treatment device 1A with an optical path of light emitted from a second light source 4B.

The fluid treatment device 1A is a device that treats a fluid by irradiating a fluid to be treated with light having a predetermined wavelength. The fluid to be treated may be a liquid or a gas. The fluid to be treated is treated by the fluid treatment device 1A to reduce the number of bacteria and viruses contained in the fluid or to reduce the activity of bacteria and viruses. That is, the fluid treatment device 1A functions as a device that performs treatment such as sterilization, disinfection, or deactivation of the fluid. In the present embodiment, a description will be mainly given of a case in which the fluid treatment device 1A performs a sterilization treatment of water W by irradiating the water W (an example of the fluid to be treated) with ultraviolet light.

The fluid treatment device 1A includes a flow path member 2, a first cover member 3A, a second cover member 3B, a first light source 4A, a second light source 4B, a first light detector 5A, a second light detector 5B, and a control device 6.

The flow path member 2 is a member that forms a flow path 20 through which the water W to be treated flows. Specifically, the flow path member 2 includes a pipe main body 21 forming the flow path 20 therein, an inlet pipe 22 connected to an inlet side of the pipe main body 21, and an outlet pipe 23 connected to an outlet side of the pipe main body 21. The inlet pipe 22 is connected to equipment (not illustrated) such as a pump and a tank on the upstream side. The outlet pipe 23 is connected to equipment (not illustrated) such as a pump and a tank on the downstream side. The water W flows in from the inlet pipe 22, flows to the outlet pipe 23 through the flow path 20, and flows out of the outlet pipe 23.

Examples of a material of the flow path member 2 that can be used include a metal material such as stainless steel. A coating film may be formed on an inner surface 210 of the pipe main body 21, and the coating film may be formed with, for example, a fluorine-based resin material or a metal material such as aluminum as a material having a high reflectance. The pipe main body 21, the inlet pipe 22, and the outlet pipe 23 may be separate members or may be an integrated member.

The first cover member 3A and the second cover member 3B are members each forming a space separated from the flow path 20. The first cover member 3A and the second cover member 3B are respectively disposed at positions facing each other across the flow path 20. Here, a space formed by the first cover member 3A and separated from the flow path 20 is referred to as a first space 30A, and a space formed by the second cover member 3B and separated from the flow path 20 is referred to as a second space 30B. In the present embodiment, the first cover member 3A is attached to an inlet side end portion of the pipe main body 21 and forms the first space 30A, which is the space separated from the flow path 20. The second cover member 3B is attached to an outlet side end portion of the pipe main body 21 and forms the second space 30B, which is the space separated from the flow path 20.

The first cover member 3A includes a housing portion 31A forming the first space 30A therein and a light-transmissive part 32A disposed between the first space 30A and the flow path 20. The second cover member 3B includes a housing portion 31B forming the second space 30B therein and a light-transmissive part 32B disposed between the second space 30B and the flow path 20.

The housing portions 31A and 31B are each formed in a box shape, for example, and are attached to the inlet side end portion and the outlet side end portion of the pipe main body 21, respectively. As a material of the housing portions 31A and 31B, a metal material or a resin material similar to that of the flow path member 2 can be used. The housing portions 31A and 31B may be formed integrally with the pipe main body 21. In this case, a part of the pipe main body 21 may serve as the housing portions 31A and 31B.

The light-transmissive parts 32A and 32B are each formed in a plate shape, for example, and are attached between the pipe main body 21 and the housing portions 31A and 31B so as to prevent the water W from entering the first space 30A and the second space 30B. The light-transmissive parts 32A and 32B respectively include first surfaces 320A and 320B disposed on the first light source 4A and the second light source 4B sides, and second surfaces 321A and 321B disposed on the flow path 20 side. The light-transmissive parts 32A and 32B are made of a material having light transmitting properties with respect to wavelengths of lights (ultraviolet light in the present embodiment) emitted by the first light source 4A and the second light source 4B. Examples of the material of the light-transmissive parts 32A and 32B that can be used include light-transmitting materials such as glass, e.g., synthetic silica and fused silica, and sapphire. The light-transmissive parts 32A and 32B may be a plate material entirely having light transmitting properties or may be a plate material partially having light transmitting properties. The light-transmissive parts 32A and 32B may include a coating film such as an antireflection film.

The first light source 4A is disposed in the first space 30A and emits light toward the flow path 20. The first light source 4A includes a substrate 40A and one or more of light-emitting elements 41A mounted on the substrate 40A. The second light source 4B is disposed in the second space 30B and emits light toward the flow path 20. The second light source 4B includes a substrate 40B and one or more light-emitting elements 41B mounted on the substrate 40B. In the present embodiment, as illustrated in FIG. 2, a plurality of (more specifically, eight) light-emitting elements 41A and a plurality of (more specifically, eight) light-emitting elements 41B are mounted on the substrates 40A and 40B, respectively, so as to surround the first light detector 5A and the second light detector 5B, respectively.

Examples of the light-emitting elements 41A and 41B that can be used include a light-emitting diode and a laser diode. The light-emitting elements 41A and 41B each include at least a semiconductor layer including an n-type semiconductor layer, a p-type semiconductor layer, a light-emitting layer, and the like, and positive and negative electrodes. The light-emitting elements 41A and 41B preferably use a nitride semiconductor layer containing, for example, In_{X}Al_{Y}Ga_{1-X-Y}N (0≤X, 0≤Y, X+Y≤1). In the present embodiment, the light-emitting elements 41A and 41B emit ultraviolet light, and the peak wavelength of the ultraviolet light may be, for example, in an ultraviolet region of 400 nm or less or in a deep ultraviolet region of 280 nm or less.

The first light source 4A and the second light source 4B energize the light-emitting elements 41A and 41B in response to a lighting command from the control device 6 to light the light-emitting elements 41A and 41B, respectively, and emit light toward the flow path 20. The first light source 4A and the second light source 4B stop energization of the light-emitting elements 41A and 41B in response to a turn-off command from the control device 6 to turn off the light-emitting elements 41A and 41B, respectively.

The first light detector 5A is disposed at a position facing the second light source 4B across the flow path 20. The second light detector 5B is disposed at a position facing the first light source 4A across the flow path 20.

The first light detector 5A is disposed in the first space 30A and receives a plurality of light fluxes. A light flux is part of light emitted from one light source toward the flow path 20. The first light detector 5A receives a light flux which is part of light emitted from the first light source 4A toward the flow path 20 and a light flux which is part of light emitted from the second light source 4B toward the flow path 20.

The second light detector 5B is disposed in the second space 30B and receives a plurality of light fluxes. A light flux is part of light emitted from one light source toward the flow path 20. The second light detector 5B receives a light flux which is part of light emitted from the first light source 4A toward the flow path 20 and a light flux which is part of light emitted from the second light source 4B toward the flow path 20.

Examples of the first light detector 5A and the second light detector 5B that can be used include a light-detecting element such as a photodetector, a photodiode, and a phototransistor. In the present embodiment, as illustrated in FIG. 2, the first light detector 5A and the second light detector 5B are mounted on the substrates 40A and 40B and are disposed in central portions thereof so as to be surrounded by the plurality of light-emitting elements 41A and 41B disposed in a distributed manner, respectively.

As illustrated in FIGS. 3 and 4, the plurality of light fluxes received by the first light detector 5A and the second light detector 5B include light fluxes LA1 and LB1 that reach the first light detector 5A and the second light detector 5B, respectively, without passing through the flow path 20 and light fluxes LA2 and LB2 that reach the first light detector 5B and the second light detector 5A, respectively, after passing through the flow path 20.

Specifically, the first light detector 5A receives the light flux LA1, which is part of the light emitted from the first light source 4A toward the flow path 20, is reflected by the light-transmissive part 32A of the first cover member 3A, and reaches the first light detector 5A without passing through the flow path 20, and the light flux LB2, which is part of the light emitted from the second light source 4B toward the flow path 20, is transmitted through the light-transmissive part 32A, and reaches the first light detector 5A after passing through the flow path 20. The second light detector 5B receives the light flux LB1, which is part of the light emitted from the second light source 4B toward the flow path 20, is reflected by the light-transmissive part 32B of the second cover member 3B, and reaches the second light detector 5B without passing through the flow path 20, and the light flux LA2, which is part of the light emitted from the first light source 4A toward the flow path 20, is transmitted through the light-transmissive part 32B, and reaches the second light detector 5B after passing through the flow path 20.

The first light detector 5A and the second light detector 5B output electrical signals corresponding to an amount of light received by the first light detector 5A and an amount of light received by the second light detector 5B, respectively. The control device 6 acquires data indicating light amount values based on the electrical signals. Hereinafter, the data indicating a light amount value acquired in this manner is simply referred to as a “light amount value”.

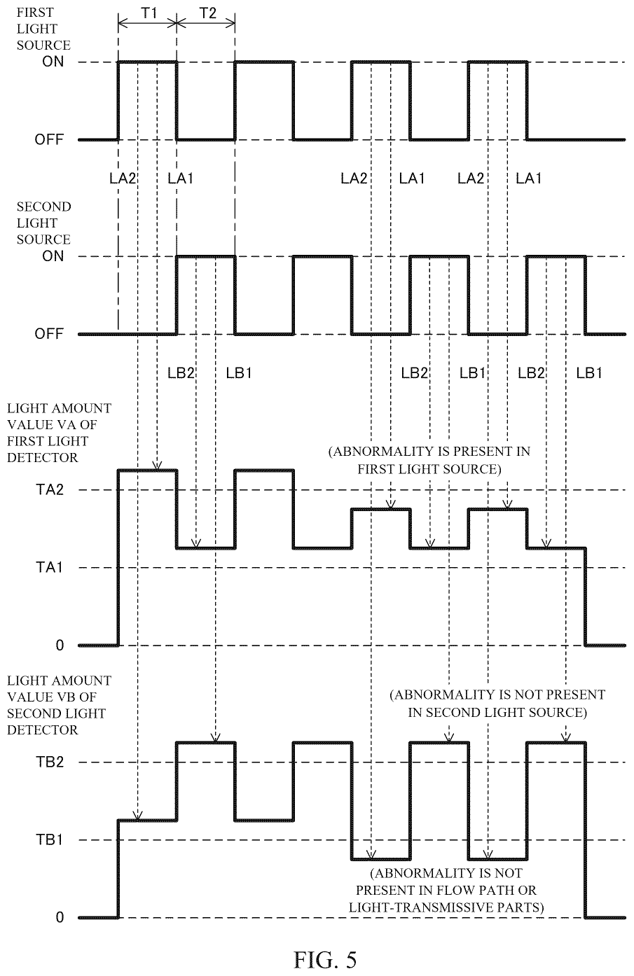

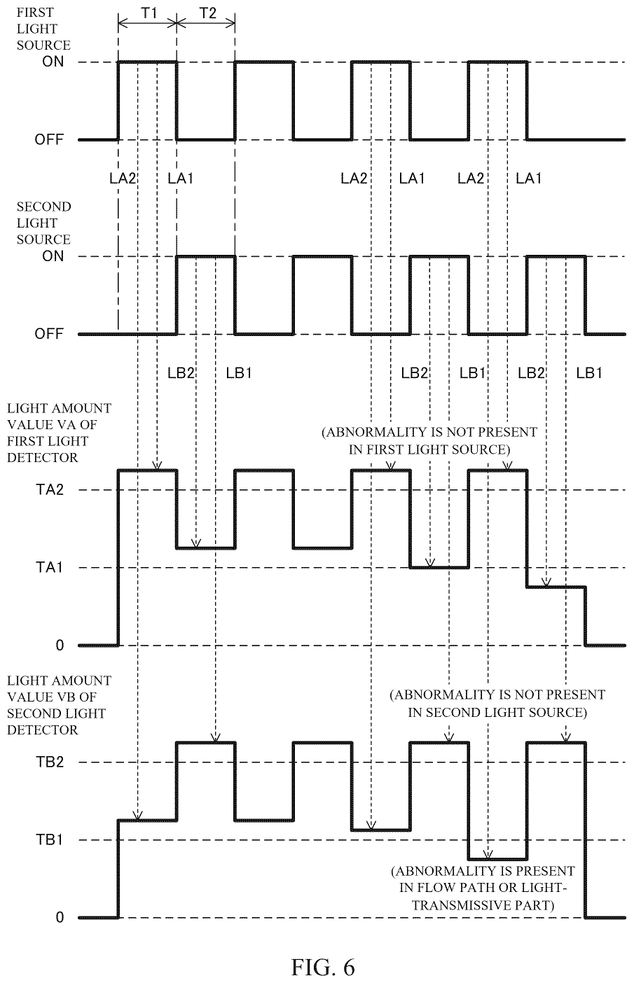

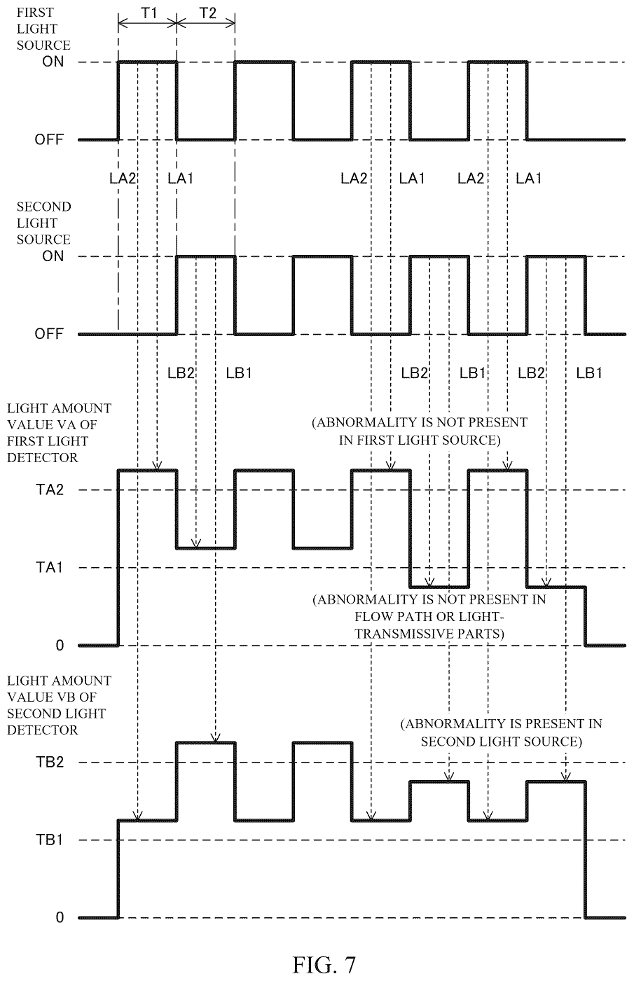

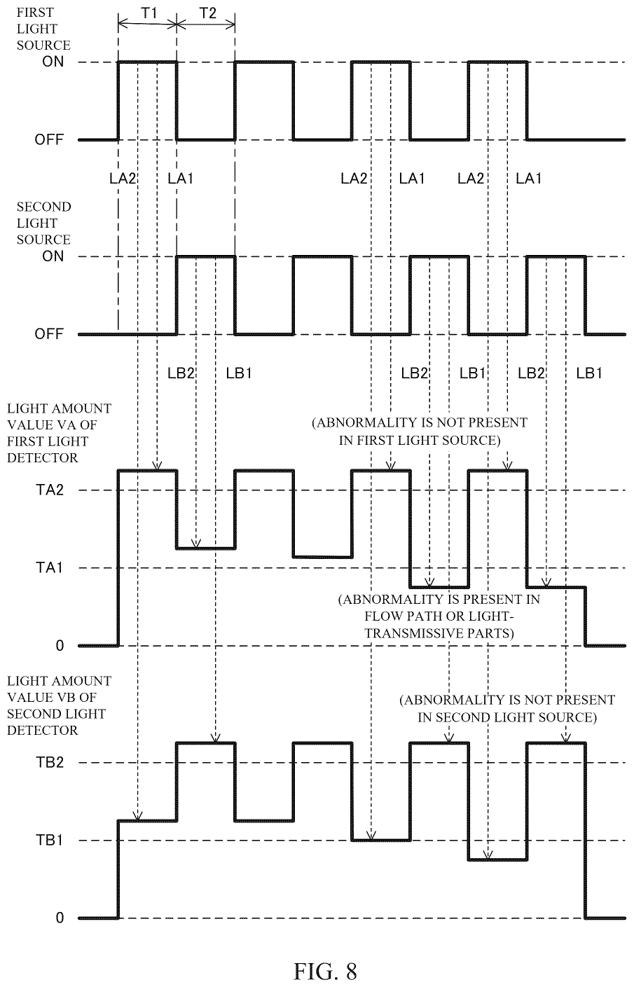

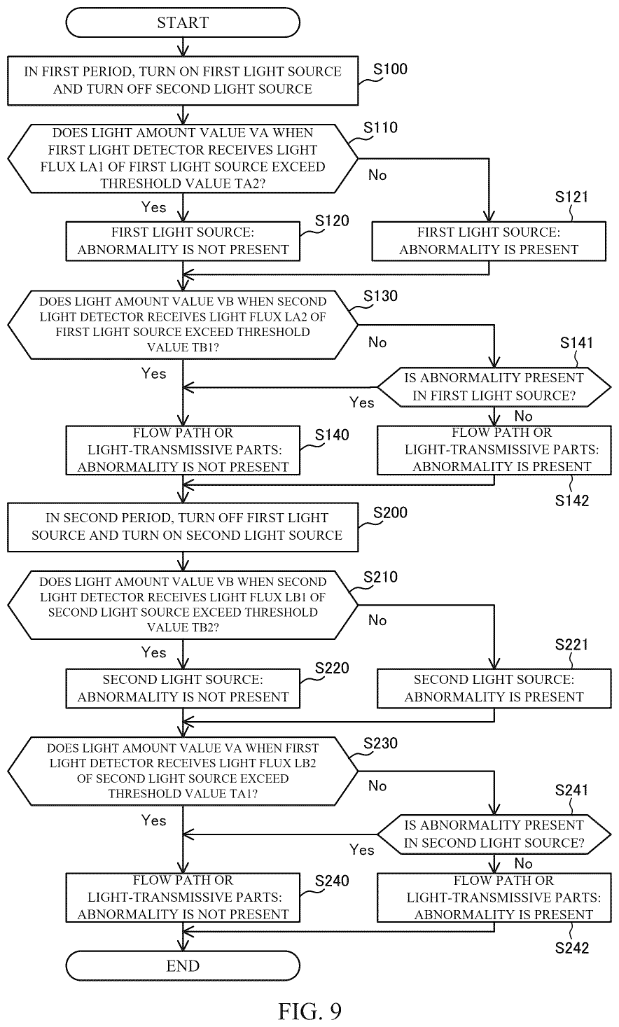

FIG. 5 is a timing chart showing an example of abnormality detection processing when an abnormality of the first light source 4A is detected. FIG. 6 is a timing chart showing an example of abnormality detection processing when an abnormality of a flow path 20 or light-transmissive parts 32A and 32B is detected based on the light amount value VA obtained by the first light detector 5A. FIG. 7 is a timing chart showing an example of abnormality detection processing when an abnormality of the second light source 4B is detected. FIG. 8 is a timing chart showing an example of abnormality detection processing when an abnormality of the flow path 20 or the light-transmissive parts 32A and 32B is detected based on the light amount value VB obtained by the second light detector 5B. FIG. 9 is a flowchart showing an example of abnormality detection processing.

The control device 6 includes a light output controller 60 that controls the first light source 4A and the second light source 4B, and an abnormality detection controller 61 that performs abnormality detection processing of detecting an abnormality of each component of the fluid treatment device 1A.

The control device 6 includes, for example, a processor such as a CPU, a memory, and an input/output circuit. The processor transmits a lighting command or a turn-off command to the first light source 4A and the second light source 4B. The processor receives the light amount values VA and VB obtained by the first light detector 5A and the second light detector 5B, respectively. The received light amount values VA and VB are stored in the memory. Various setting values (a first period, a second period, a threshold value, and the like which will be described below) which are referred to by the light output controller 60 and the abnormality detection controller 61 are stored in the memory. The light output controller 60 and the abnormality detection controller 61 may be configured by separate modules. The separate modules of the control device 6 may be mounted on the substrates 40A and 40B, respectively.

The light output controller 60 controls an output of the light emitted by the first light source 4A and the output of the light emitted by the second light source 4B. At this time, the light output controller 60 controls the first light source 4A and the second light source 4B by switching between a normal operation mode when the sterilization treatment of the water W is performed and an abnormality detection mode when the abnormality detection processing is performed by the abnormality detection controller 61. As for the timing of switching to the abnormality detection mode, for example, switching may be performed every time a predetermined set time elapses, or switching may be performed in accordance with an instruction of a user.

In the normal operation mode, the light output controller 60 controls the first light source 4A to emit light and controls the second light source 4B to emit light. That is, the first light source 4A and the second light source 4B are turned on to perform the sterilization treatment of the water W flowing through the flow path 20.

In the abnormality detection mode, each step shown in FIG. 9 is executed by the light output controller 60 and the abnormality detection controller 61. As shown in step S100, in a first period T1, the light output controller 60 controls the first light source 4A to emit light and controls the second light source 4B not to emit light. As shown in step S200, in a second period T2, the light output controller 60 controls the first light source 4A not to emit light and controls the second light source 4B to emit light.

At this time, as shown in FIGS. 5 to 8, the light output controller 60 performs pulse lighting of the first light source 4A and pulse lighting of the second light source 4B to perform lighting in a time-division manner. That is, the light output controller 60 controls the first light source 4A and the second light sources 4B such that a turn-off period in which the second light source 4B is turned off overlaps the first period T1 in which the first light source 4A is turned on, and such that a turn-off period in which the first light source 4A is turned off overlaps the second period T2 in which the second light source 4B is turned on. The pulse lighting of the first light source 4A and the second light source 4B may be repeatedly performed as shown in FIGS. 5 to 8, or may be performed only once. Between the first period T1 and the second period T2, there may be a period in which both the first light source 4A and the second light source 4B are turned on.

The abnormality detection controller 61 performs the abnormality detection processing of detecting at least two abnormalities among an abnormality of the first light source 4A, an abnormality of the second light source 4B, and an abnormality of the flow path 20 or the light-transmissive parts 32A and 32B based on the amount of light received by the first light detector 5A and the amount of light received by the second light detector 5B. Examples of causes of the abnormalities of the first light source 4A and the second light source 4B include a sudden failure of the first light source 4A and the second light source 4B. Examples of a cause of the abnormality of the flow path 20 or the light-transmissive parts 32A and 32B include contamination attached to the inner surface 210 of the pipe main body 21 and contamination attached to the second surfaces 321A and 321B of the light-transmissive parts 32A and 32B.

First, as shown in steps S110 to S142, in the first period T1, the abnormality detection controller 61 operates to detect the abnormality of the first light source 4A and the abnormality of the flow path 20 or the light-transmissive parts 32A and 32B through which the light emitted from the first light source 4A passes, based on the light amount value VA of the light flux LA1 received by the first light detector 5A and the light amount value VB of the light flux LA2 received by the second light detector 5B.

For example, in the first period T1, it is determined whether the light amount value VA when the first light detector 5A receives the light flux LA1 of the first light source 4A exceeds a threshold value TA2 (step S110). If the light amount value VA exceeds the threshold value TA2 (Yes in step S110), then it is determined that “the abnormality is not present” for the first light source 4A (step S120). If the light amount value VA does not exceed the threshold value TA2 (No in step S110), then it is determined that “the abnormality is present” for the first light source 4A (step S121, see FIG. 5). Since the light flux LA1 is a light flux that has reached the first light detector 5A without passing through the flow path 20, the light amount value VA does not reflect the influence of the contamination of the flow path 20 or the light-transmissive parts 32A and 32B. Thus, presence or absence of the abnormality of the first light source 4A can be accurately determined.

Further, in the first period T1, it is determined whether the light amount value VB when the second light detector 5B receives the light flux LA2 of the first light source 4A exceeds a threshold value TB1 (step S130). If the light amount value VB exceeds the threshold value TB1 (Yes in step S130), then it is determined that “the abnormality is not present” for the flow path 20 and the light-transmissive parts 32A and 32B (step S140). In a case in which the light amount value VB does not exceed the threshold value TB1 (No in step S130), if it is determined that “the abnormality is not present” for the first light source 4A (No in step S141), then it is determined that “the abnormality is present” for the flow path 20 or the light-transmissive parts 32A and 32B (step S142, see FIG. 6). Even in a case in which the light amount value VB does not exceed the threshold value TB1, if it is determined that “the abnormality is present” for the first light source 4A (Yes in step S141), then it is determined that “the abnormality is not present” for the flow path 20 and the light-transmissive parts 32A and 32B (step S140, see FIG. 5). Since the light flux LA2 is a light flux that has reached the second light detector 5B after passing through the flow path 20, the light amount value VB reflects the influence of the contamination of the flow path 20 or the light-transmissive parts 32A and 32B. Thus, the presence or absence of the abnormality of the flow path 20 or the light-transmissive parts 32A and 32B can be accurately determined.

As shown in steps S210 to S242, in the second period T2, the abnormality detection controller 61 detects the abnormality of the second light source 4B and the abnormality of the flow path 20 or the light-transmissive parts 32A and 32B through which the light emitted from the second light source 4B passes, based on the light amount value VB of the light flux LB1 received by the second light detector 5B and the light amount value VA of the light flux LB2 received by the first light detector 5A.

For example, in the second period T2, it is determined whether the light amount value VB when the second light detector 5B receives the light flux LB1 of the second light source 4B exceeds a threshold value TB2 (step S210). If the light amount value VB exceeds the threshold value TB2 (Yes in step S210), then it is determined that “the abnormality is not present” for the second light source 4B (step S220). If the light amount value VB does not exceed the threshold value TB2 (No in step S210), then it is determined that “the abnormality is present” for the second light source 4B (step S221, refer to FIG. 7). Since the light flux LB1 is a light flux that has reached the second light detector 5B without passing through the flow path 20, the light amount value VB does not reflect the influence of the contamination of the flow path 20 or the light-transmissive parts 32A and 32B. Thus, presence of the abnormality of the second light source 4B can be accurately determined.

Further, in the second period T2, it is determined whether the light amount value VA when the first light detector 5A receives the light flux LB2 of the second light source 4B exceeds a threshold value TA1 (step S230). If the light amount value VA exceeds the threshold value TA1 (Yes in step S230), then it is determined that “the abnormality is not present” for the flow path 20 and the light-transmissive parts 32A and 32B (step S240). In a case in which the light amount value VA does not exceed the threshold value TA1 (No in step S230), if it is determined that “the abnormality is not present” for the second light source 4B (No in step S241), then it is determined that “the abnormality is present” for the flow path 20 or the light-transmissive parts 32A and 32B (step S242, refer to FIG. 8). Even in a case in which the light amount value VA does not exceed the threshold value TA1, if it is determined that “the abnormality is present” for the second light source 4B (Yes in step S241), then it is determined that “the abnormality is not present” for the flow path 20 and the light-transmissive parts 32A and 32B (step S240, see FIG. 7). Since the light flux LB2 is a light flux that has reached the first light detector 5A after passing through the flow path 20, the light amount value VA reflects the influence of the contamination of the flow path 20 or the light-transmissive parts 32A and 32B. Thus, the presence or absence of the abnormality of the flow path 20 or the light-transmissive parts 32A and 32B can be accurately determined.

The threshold values TA2 and TB2 used in the abnormality detection processing of the first light source 4A and the second light source 4B, respectively, may be fixed values or variable values. In the case in which they are fixed values, for example, respective values obtained by multiplying the light amount values VA and VB when the light fluxes LA1 and LB1, respectively, are received in a manufacturing stage or an installation stage by a predetermined coefficient or respective values obtained by subtracting a predetermined value from the light amount values VA and VB are set. In the case in which they are variable values, for example, respective values obtained by multiplying corresponding mean values of the light amount values VA and VB when the light fluxes LA1 and LB1, respectively, are received in a past predetermined period by a predetermined coefficient or respective values obtained by subtracting a predetermined value from the mean values are set. The threshold values TA1 and TB1 used in the abnormality detection processing of the flow path 20 or the light-transmissive parts 32A and 32B may be fixed values or variable values. In the case in which they are fixed values, for example, respective values obtained by multiplying the light amount values VA and VB when the light fluxes LA2 and LB2, respectively, are received in a manufacturing stage or an installation stage by a predetermined coefficient or respective values obtained by subtracting a predetermined value from the light amount values VA and VB are set. In the case in which they are variable values, for example, values obtained by multiplying corresponding mean values of the light amount values VA and VB when the light fluxes LA2 and LB2, respectively, are received in a past predetermined period by a predetermined coefficient or respective values obtained by subtracting a predetermined value from the mean values are set.

As described above, in the fluid treatment device 1A according to the first embodiment, the first light detector 5A and the second light detector 5B can receive the light fluxes LA1 and LB1, respectively, that have not passed through the flow path 20 and the light fluxes LB2 and LA2, respectively, that have passed through the flow path 20. Thus, the device configuration can be simplified.

In particular, since the first light detector 5A and the second light detector 5B separately receive the light flux LA1 and the light flux LA2, and the light flux LB1 and the light flux LB2 in the first period T1 and the second period T2, respectively, a location where an abnormality has occurred in the fluid treatment device 1A can be identified.

### Second Embodiment

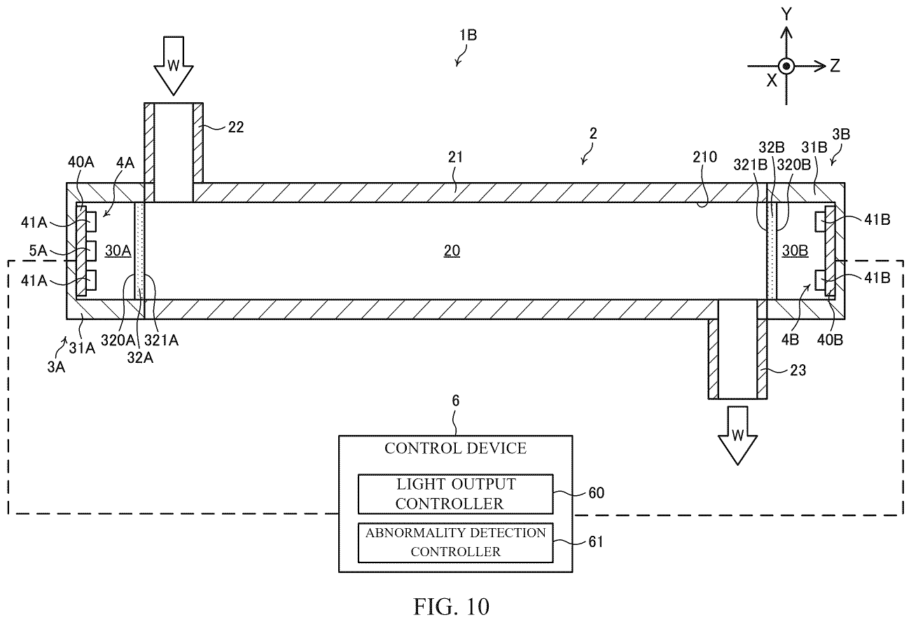

FIG. 10 schematically illustrates a cross-sectional view of an example of a fluid treatment device 1B according to a second embodiment. The fluid treatment device 1B according to the second embodiment is different from the fluid treatment device 1A according to the first embodiment in that the second light detector 5B is not provided. Since the other basic configurations and operations are similar to those of the fluid treatment device 1A according to the first embodiment, the following description will focus on the differences between the two.

As illustrated in FIG. 10, the fluid treatment device 1B includes a flow path member 2, a first cover member 3A, a second cover member 3B, a first light source 4A, a second light source 4B, a first light detector 5A, and a control device 6.

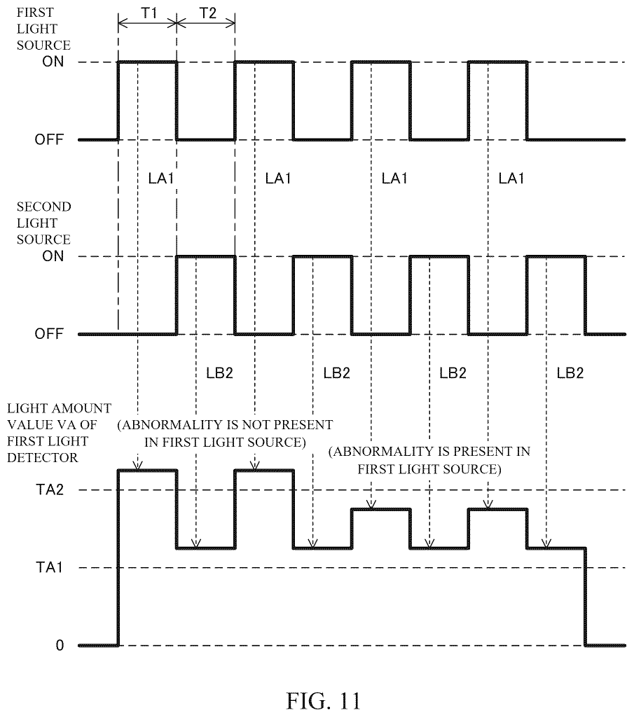

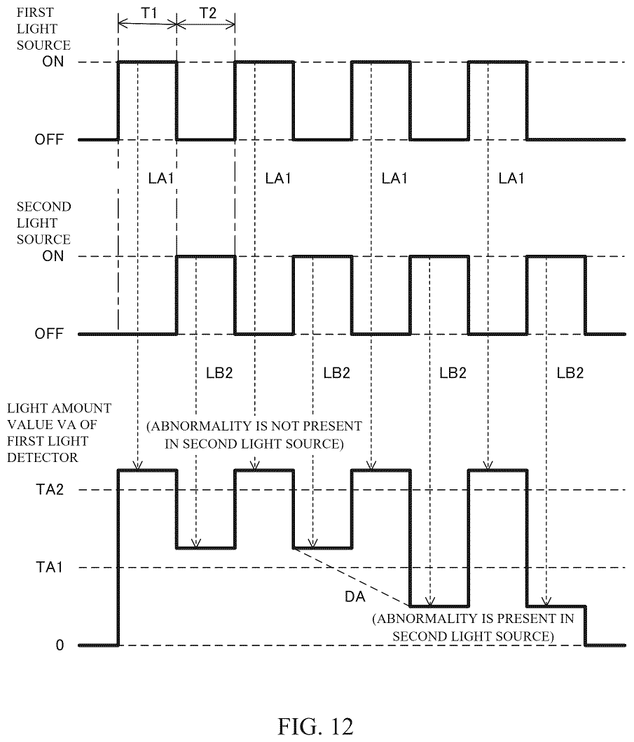

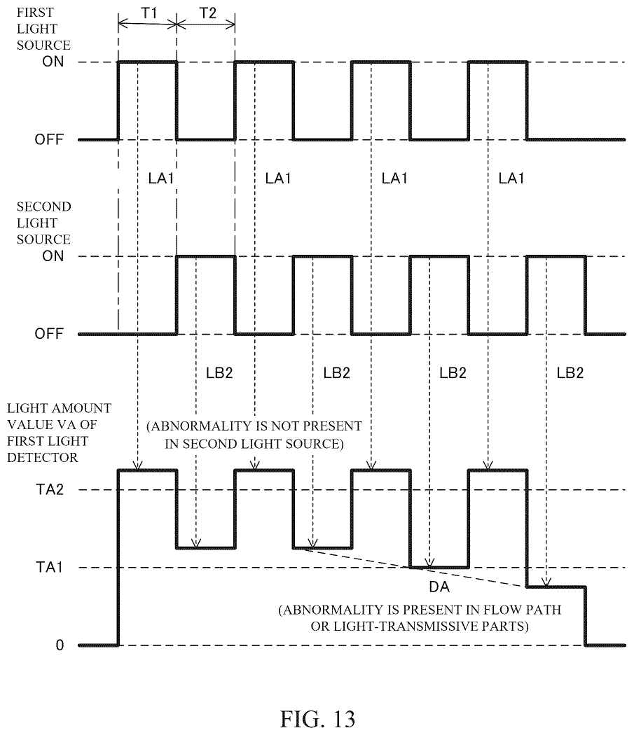

FIG. 11 is a timing chart showing an example of abnormality detection processing when an abnormality of the first light source 4A is detected. FIG. 12 is a timing chart showing an example of abnormality detection processing when an abnormality of the second light source 4B is detected. FIG. 13 is a timing chart showing an example of abnormality detection processing when an abnormality of the flow path 20 or light-transmissive parts 32A and 32B is detected.

As in the first embodiment, the light output controller 60 controls the first light source 4A and the second light source 4B, switching between the normal operation mode and the abnormality detection mode. In the abnormality detection mode, the light output controller 60 controls the first light source 4A emit light and controls the second light source 4B not to emit light in the first period T1, and controls the first light source 4A not to emit light and the second light source 4B to emit light in the second period T2.

The abnormality detection controller 61 performs abnormality detection processing of detecting at least two abnormalities among an abnormality of the first light source 4A, an abnormality of the second light source 4B, and an abnormality of the flow path 20 or the light-transmissive parts 32A and 32B based on the amount of light received by the first light detector 5A.

Specifically, in the first period T1, the abnormality detection controller 61 detects an abnormality of the first light source 4A based on the light amount of the light flux LA1 received by the first light detector 5A.

For example, in the first period T1, it is determined whether the light amount value VA when the first light detector 5A receives the light flux LA1 of the first light source 4A exceeds the threshold value TA2. If the light amount value VA exceeds the threshold value TA2, then it is determined that “the abnormality is not present” for the first light source 4A. If the light amount value VA does not exceed the threshold value TA2, then it is determined that “the abnormality is present” for the first light source 4A (see FIG. 11).

In addition, in the second period T2, the abnormality detection controller 61 detects an abnormality of the second light source 4B and an abnormality of the flow path 20 or the light-transmissive parts 32A and 32B through which the light emitted from the second light source 4B passes, based on the light amount of the light flux LB2 received by the first light detector 5A.

For example, in the second period T2, if the light amount value VA when the first light detector 5A receives the light flux LB2 of the second light source 4B exceeds the threshold value TA1, then it is determined that “the abnormality is not present” for the second light source 4B, and it is determined that “the abnormality is not present” for the flow path 20 and the light-transmissive parts 32A and 32B. If the light amount value VA does not exceed the threshold value TA1, then it is determined whether an over-time deterioration DA of the light amount value VA exceeds a threshold value.

The over-time deterioration DA of the light amount value VA is a degree when the light amount value VA decreases over time. The over-time deterioration DA is calculated, for example, by dividing a difference value between the light amount value VA output before the timing of the previous abnormality detection mode and the light amount value VA output at the timing of the current abnormality detection mode by a time interval between the timings. The over-time deterioration DA may be a difference value between the light amount values VA. Similarly to the threshold values TA1 and TA2, a threshold value for the over-time deterioration DA may be a fixed value or a variable value. In the case in which it is a fixed value, for example, it is set in a manufacturing stage or an installation stage. In the case in which it is a variable value, for example, a value obtained by multiplying a mean value of the over-time deterioration DA of the light amount value VA when the light flux LA1 is received in a past predetermined period by a predetermined coefficient or a value obtained by subtracting a predetermined value from the mean value is set.

If the over-time deterioration DA of the light amount value VA exceeds the threshold value, then it is determined that “the abnormality is present” for the second light source 4B (see FIG. 12). If the over-time deterioration DA of the light amount value VA does not exceed the threshold value, then it is determined that “the abnormality is present” for the flow path 20 or the light-transmissive parts 32A and 32B (see FIG. 13). The reason why the determination is made as described above is that the degree of decrease of the light amount value VA is relatively large in the case of a sudden failure that is the cause of the abnormality of the second light source 4B, whereas the degree of decrease of the light amount value VA is relatively small in the case of contamination attached to the pipe main body 21 or the light-transmissive parts 32A, 32B that is the cause of the abnormality of the flow path 20 or the light-transmissive parts 32A and 32B.

As described above, in the fluid treatment device 1B according to the second embodiment, the first light detector 5A can receive the light flux LA1 that has not passed through the flow path 20 and the light flux LB2 that has passed through the flow path 20. Thus, the device configuration can be simplified.

In particular, since the first light detector 5A receives the light flux LA1 and the light flux LB2 separately in the first period T1 and the second period T2, a location where an abnormality has occurred in the fluid treatment device 1B can be identified.

### Third Embodiment

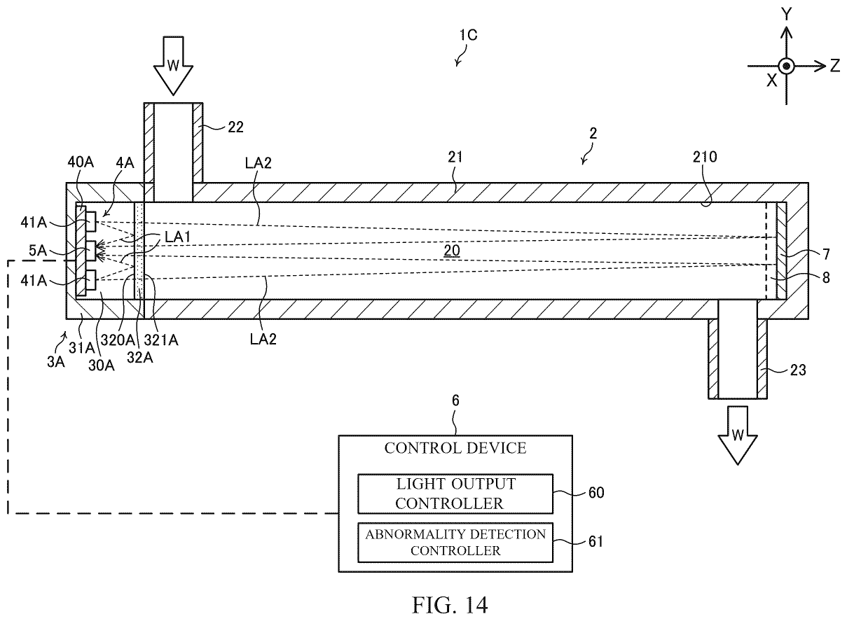

FIG. 14 schematically illustrates a cross-sectional view of an example of a fluid treatment device 1C according to a third embodiment. The fluid treatment device 1C according to the third embodiment is different from the fluid treatment device 1A according to the first embodiment in that the second cover member 3B, the second light source 4B, and the second light detector 5B are not provided, but a reflective member 7 and a shutter member 8 are provided. Since the other basic configurations and operations are similar to those of the fluid treatment device 1A according to the first embodiment, the following description will focus on the differences between the two.

As illustrated in FIG. 14, the fluid treatment device 1C includes the flow path member 2, the first cover member 3A, the first light source 4A, the first light detector 5A, the control device 6, the reflective member 7, and the shutter member 8.

The reflective member 7 is disposed at a position facing the first light source 4A across the flow path 20 and reflects light having been emitted from the first light source 4A and passed through the flow path 20. Similarly to the inner surface 210 of the pipe main body 21, a surface of the reflective member 7 may be provided with a coating film formed of a material having a high reflectance. The reflective member 7 may be a coating film formed on the inner surface 210 of the pipe main body 21 at a position at which the reflective member 7 is disposed.

The shutter member 8 is a member that can shield the reflective member 7, and can move between a closed position at which the reflective member 7 is shielded and an open position at which the reflective member 7 is not shielded. A coating film is formed of a material having a low reflectance, on the surface of the shutter member 8. Examples of a moving mechanism of the shutter member 8 that can be used include an actuator such as a motor, a solenoid, or a cylinder.

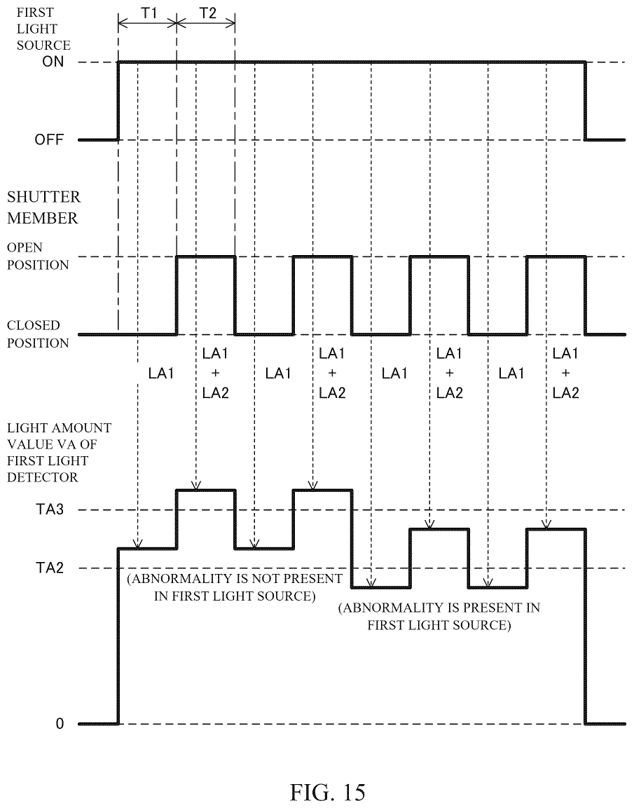

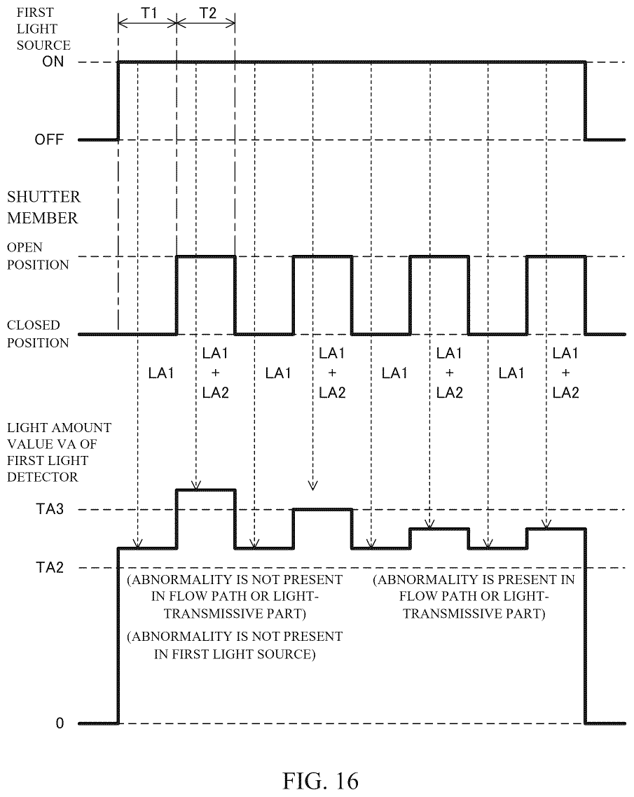

FIG. 15 is a timing chart showing an example of abnormality detection processing when an abnormality of the first light source 4A is detected. FIG. 16 is a timing chart showing an example of abnormality detection processing when an abnormality of the flow path 20 or the light-transmissive part 32A is detected.

As in the first embodiment, the light output controller 60 controls the first light source 4A and the shutter member 8, switching between the normal operation mode and the abnormality detection mode. In the abnormality detection mode, the light output controller 60 controls the first light source 4A to emit light and the shutter member 8 to be at the closed position in the first period T1, and controls the first light source 4A to emit light and the shutter member 8 to be at the open position in the second period T2.

The abnormality detection controller 61 performs abnormality detection processing of detecting an abnormality of the first light source 4A and an abnormality of the flow path 20 or the light-transmissive part 32A based on the amount of light received by the first light detector 5A.

Specifically, in the first period T1 in which the shutter member 8 is at the closed position, the abnormality detection controller 61 detects an abnormality of the first light source 4A based on the light amount of the light flux LA1 received by the first light detector 5A.

For example, in the first period T1, it is determined whether the light amount value VA when the first light detector 5A receives the light flux LA1 of the first light source 4A exceeds the threshold value TA2. If the light amount value VA exceeds the threshold value TA2, then it is determined that “the abnormality is not present” for the first light source 4A. If the light amount value VA does not exceed the threshold value TA2, then it is determined that “the abnormality is present” for the first light source 4A (see FIG. 15).

In addition, in the second period T2 in which the shutter member 8 is at the open position, the abnormality detection controller 61 detects an abnormality of the flow path 20 or the light-transmissive part 32A based on the light amounts of the light flux LA1 and the light flux LA2 received by the first light detector 5A.

For example, in the second period T2, if the light amount value VA when the first light detector 5A receives the light flux LA1 and the light flux LA2 of the first light source 4A exceeds a threshold value TA3, then it is determined that “the abnormality is not present” for the flow path 20 and the light-transmissive part 32A. In a case where the light amount value VA does not exceed the threshold value TA3, if it is determined that “the abnormality is not present” for the first light source 4A, then it is determined that “the abnormality is present” for the flow path 20 or the light-transmissive part 32A (see FIG. 16). Even in a case in which the light amount value VA does not exceed the threshold value TA3, if it is determined that “the abnormality is present” for the first light source 4A, then it is determined that “the abnormality is not present” for the flow path 20 and the light-transmissive part 32A.

As described above, in the fluid treatment device 1C according to the third embodiment, the first light detector 5A can receive the light flux LA1 that has not passed through the flow path 20 and the light flux LA2 that has passed through the flow path 20. Thus, the device configuration can be simplified.

In particular, since the first light detector 5A receives the light flux LA1 and the light flux LA2 separately in the first period T1 and the second period T2, a location where an abnormality has occurred in the fluid treatment device 1C can be identified.

### Fourth Embodiment

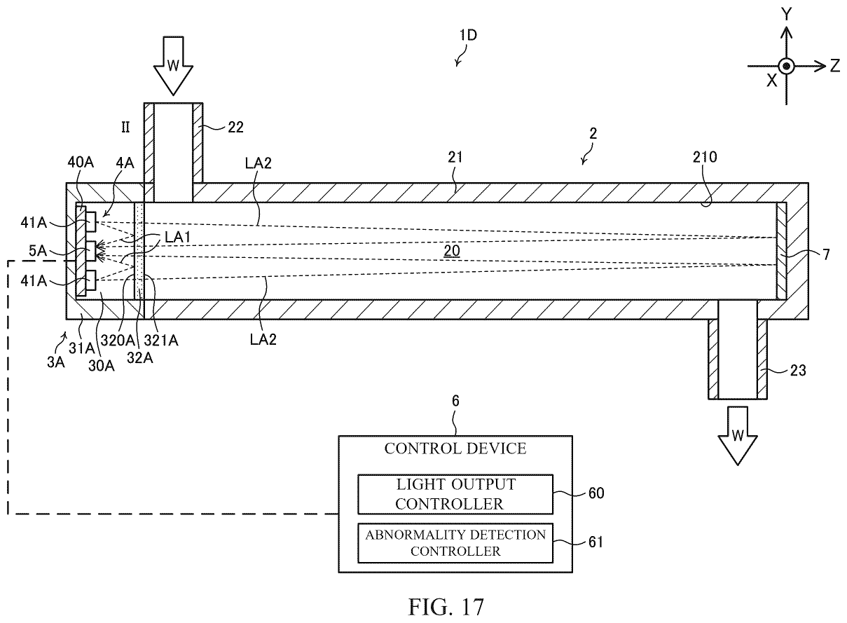

FIG. 17 schematically illustrates a cross-sectional view of an example of a fluid treatment device 1D according to a fourth embodiment. The fluid treatment device 1D according to the fourth embodiment is different from the fluid treatment device 1C according to the third embodiment in that the shutter member 8 is not provided. Since the other basic configurations and operations are similar to those of the fluid treatment device 1C according to the third embodiment, the following description will focus on the differences between the two.

As illustrated in FIG. 17, the fluid treatment device 1D includes the flow path member 2, the first cover member 3A, the first light source 4A, the first light detector 5A, the control device 6, and the reflective member 7.

The light output controller 60 controls the first light source 4A without switching between the normal operation mode and the abnormality detection mode. For example, the abnormality detection controller 61 detects an abnormality of the first light source 4A and an abnormality of the flow path 20 or the light-transmissive part 32A based on the light amounts of the light flux LA1 and the light flux LA2 received by the first light detector 5A.

For example, if the light amount value VA when the first light detector 5A receives the light flux LA1 and the light flux LA2 exceeds the threshold value TA1, then it is determined that “the abnormality is not present” for the first light source 4A, and it is determined that “the abnormality is not present” for the flow path 20 and the light-transmissive part 32A. If the light amount value VA does not exceed the threshold value TA1, then it is determined whether an over-time deterioration DA of the light amount value VA exceeds a threshold value. If the over-time deterioration DA of the light amount value VA exceeds the threshold value, then it is determined that “the abnormality is present” for the first light source 4A. If the over-time deterioration DA of the light amount value VA does not exceed the threshold value, then it is determined that “the abnormality is present” for the flow path 20 or the light-transmissive part 32A.

As described above, in the fluid treatment device 1D of the fourth embodiment, the first light detector 5A can receive the light flux LA1 that has not passed through the flow path 20 and the light flux LA2 that has passed through the flow path 20. Thus, the device configuration can be simplified.

### OTHER EMBODIMENTS

Although the embodiments of the present invention have been described above, the present invention is not limited to the above embodiments and can be appropriately changed without departing from the technical concepts of the present invention.

In the first and second embodiments, the case has been described in which the fluid treatment devices 1A and 1B each include two cover members and two light sources disposed in respective spaces formed by the two cover members. In the third and fourth embodiments, the case has been described in which the fluid treatment devices 1C and 1D each include one cover member and one light source disposed in a space formed by the one cover member. On the other hand, the fluid treatment device may include three or more cover members and three or more light sources disposed in respective spaces formed by the three cover members.

In the above embodiment, the case has been described in which the fluid treatment devices 1A to 1D each include the control device 6. On the other hand, the first light source 4A and the second light source 4B, and the first light detector 5A and the second light detector 5B may be connected to external control equipment, and the external control equipment may operate as the control device 6. In this case, the fluid treatment devices 1A to 1D need not include the control device 6.

In the embodiment described above, the case has been described in which the abnormality detection controller 61 performs the abnormality detection processing of detecting an abnormality of each component based on the light amount values VA and VB of the lights received by the first light detector 5A and the second light detector 5B, respectively. On the other hand, the abnormality detection controller 61 may further detect an abnormality of the first light detector 5A or an abnormality of the second light detector 5B as an abnormality of each unit. For example, in the first period T1, if the light amount value VA of the light flux LA1 received by the first light detector 5A does not exceed a threshold value (<threshold value TA2) for the light detector and the light amount value VB of the light flux LA2 received by the second light detector 5B exceeds the threshold value TB1, then the abnormality detection controller 61 may determine that the first light detector 5A is abnormal. Similarly, in the second period T2, if the light amount value VB of the light flux LB1 received by the second light detector 5B does not exceed a threshold value (<threshold value TB2) for the light detector and the light amount value VA of the light flux LB2 received by the first light detector 5A exceeds the threshold value TA1, then the abnormality detection controller 61 may determine that the second light detector 5B is abnormal.

The light amount values VA and VB of the lights received by the first light detector 5A and the second light detector 5B, respectively, may be used for other purposes in addition to or instead of the abnormality detection processing. For example, the light amount values VA and VB may be used to adjust the intensities of the lights emitted from the first light source 4A and the second light source 4B, respectively. The light amount values VA and VB may be used to estimate the effect of the sterilization treatment on the water W. When the light amount values VA and VB are used for other purposes instead of the abnormality detection processing, the fluid treatment devices 1A to 1D need not include the abnormality detection controller 61.

What is claimed is:

1. A fluid treatment device comprising:
a flow path member having a flow path through which a fluid to be treated flows;
a first cover member provided at a first end of the flow path member in a flow direction, the first cover member forming a first space separated from the flow path and comprising a first light-transmissive part disposed between the first space and the flow path;
a first light source disposed in the first space and configured to emit light toward the flow path; and
a first light detector disposed in the first space and configured to receive a first light flux that is emitted from the first light source and reaches the first light detector without passing through the flow path and a second light flux that is emitted from the first light source and reaches the first light detector after passing through the flow path.

2. The fluid treatment device according to claim 1, wherein
the first light flux, after being emitted from the first light source, is reflected by the first light-transmissive part to reach the first light detector, and
the second light flux, after being emitted from the first light source, passes the first light-transmissive part and then proceeds to the flow path.

3. The fluid treatment device according to claim 1, wherein
the first light detector is disposed on a substrate, and
the first light source includes three or more light emitting elements arranged around the first light detector, on the substrate.

4. The fluid treatment device according to claim 1, further comprising:
a controller configured to perform abnormality detection processing of detecting: i) an abnormality of the first light source; and ii) an abnormality of the flow path or the first light-transmissive part, based on an amount of light received by the first light detector while the first light source is turned on.

5. The fluid treatment device according to claim 4, wherein
the controller detects the abnormality of the first light source based on comparison of the amount of light received by the first light detector with a first threshold, and
the controller detects the abnormality of the flow path or the first light-transmissive part based on comparison of an over-time deterioration of the amount of light received by the first light detector with a second threshold.

6. The fluid treatment device according to claim 1, further comprising:
a reflective member disposed at a second end of the flow path member opposite to the first end in the flow direction and facing the first light source across the flow path, wherein the second light flux is reflected by the reflective member during passing through the flow path.

7. The fluid treatment device according to claim 6, further comprising:
a shutter member disposed between the reflective member and the flow path and configured to move between a closed position at which the shutter member blocks light proceeding toward the reflective member and an open position at which the light proceeding toward the reflective member is unblocked.

8. The fluid treatment device according to claim 7, further comprising:
a controller configured to perform abnormality detection processing of detecting: i) an abnormality of the first light source; and ii) an abnormality of the flow path or the first light-transmissive part, based on an amount of light received by the first light detector while the first light source is turned on.

9. The fluid treatment device according to claim 8, wherein
the controller is configured to control the shutter member to be in the closed position in a first period and in the open position in a second period, while the first light source is turned on, and
the controller detects the abnormality of the first light source and the abnormality of the flow path or the first light-transmissive part, based on comparison of the amount of light received by the first light detector in the first period with a first threshold and comparison of the amount of light received by the first light detector in the second period with a second threshold greater than the first threshold.

10. The fluid treatment device according to claim 1, further comprising:
a second cover member provided at a second end of the flow path member in the flow direction, the second cover member forming a second space separated from the flow path and comprising a second light-transmissive part disposed between the second space and the flow path; and
a second light source disposed in a second space and configured to emit light toward the flow path, wherein
the first light detector is configured to receive a third light flux that is emitted from the second light source toward the flow path.

11. The fluid treatment device according to claim 10, further comprising:
a first controller configured to perform abnormality detection processing of detecting at least two abnormalities among: i) an abnormality of the first light source; ii) an abnormality of the second light source; and iii) an abnormality of the flow path, the first light-transmissive part, or the second light-transmissive part, based on an amount of the light received by the first light detector.

12. The fluid treatment device according to claim 11, further comprising
a second controller configured to turn on the first light source and turn off the second light source in a first period, and turn off the first light source and turn on the second light source in a second period,
the first controller detects the abnormality of the first light source based on an amount of light received by the first light detector in the first period, and
the first controller detects at least one of the abnormality of the second light source and the abnormality of the flow path, the first light-transmissive part, or the second light-transmissive part, based on an amount of light received by the first light detector in the second period.

13. The fluid treatment device according to claim 12, wherein
the first controller detects the abnormality of the first light source based on comparison of the amount of light received by the first light detector in the first period with a first threshold, and
the first controller detects at least one of the abnormality of the second light source and the abnormality of the flow path, the first light-transmissive part, or the second light-transmissive part, based on comparison of the amount of light received by the first light detector in the second period with a second threshold less than the first threshold.

14. The fluid treatment device according to claim 13, wherein
the first controller detects the abnormality of the second light source based on determination that an over-time deterioration of the amount of light received by the first light detector in the second period is greater than a third threshold, and
the first controller detects the abnormality of the flow path, the first light-transmissive part, or the second light-transmissive part, based on determination that the over-time deterioration of the amount of light received by the first light detector in the second period is less than the third threshold.

15. The fluid treatment device according to claim 10, further comprising:
a second light detector disposed in the second space and configured to receive a third light flux that is emitted from the second light source and reaches the second light detector without passing through the flow path and a fourth light flux that is emitted from the second light source and reaches the second light detector after passing through the flow path.

16. The fluid treatment device according to claim 15, further comprising:
a first controller configured to perform abnormality detection processing of detecting at least two abnormalities among: i) an abnormality of the first light source; ii) an abnormality of the second light source; and iii) an abnormality of the flow path, the first light-transmissive part, or the second light-transmissive part, based on an amount of light received by the first light detector and an amount of light received by the second light detector.

17. The fluid treatment device according to claim 16, further comprising:
a second controller configured to turn on the first light source and turn off the second light source in a first period, and turn off the first light source and turn on the second light source in a second period, wherein
the second controller detects the abnormality of the first light source and the abnormality of the flow path, the first light-transmissive part, or the second light-transmissive part, based on an amount of light received by the first light detector in the first period and an amount of light received by the second light detector in the first period, and
the second controller detects the abnormality of the second light source and the abnormality of the flow path, the first light-transmissive part, or the second light-transmissive part, based on an amount of light received by the first light detector in the second period and an amount of light received by the second light detector in the second period.

18. The fluid treatment device according to claim 17, wherein
the first controller detects the abnormality of the first light source based on comparison of the amount of light received by the first light detector in the first period with a first threshold,
the first controller detects the abnormality of the second light source based on comparison of the amount of light received by the second light detector in the second period with a second threshold,
the first controller detects the abnormality of the flow path, the first light-transmissive part, or the second light-transmissive part, based on comparison of the amount of light received by the second light detector in the first period with a third threshold less than the second threshold and comparison of the amount of light received by the first light detector in the second period with a fourth threshold less than the first threshold.

19. The fluid treatment device according to claim 17, wherein the second controller is configured to operate in a first mode in which the second controller maintains the first light source and the second light source to be on for treatment of the fluid, and in a second mode in which the second controller maintains turns on and off the first light source and the second light source for the abnormality detection processing by the first controller.

20. The fluid treatment device according to claim 1, wherein the light emitted from the first light sources includes ultraviolet light.
